(19) United States
(12) Patent Application Publication
(10) Pub. No.: US 2026/0107154 A1
(43) Pub. Date: Apr. 16, 2026

(54) RADIO COMMUNICATION SYSTEM, RELAY STATION, AND RELAY METHOD

(71) Applicant: NTT, Inc., Tokyo (JP)

(72) Inventors: Daisuke MURAYAMA, Tokyo (JP); Toshiro NAKAHIRA, Tokyo (JP); So TAKATANI, Tokyo (JP)

(73) Assignee: NTT, Inc., Tokyo (JP)

(21) Appl. No.: 18/881,278

(22) PCT Filed: Jul. 7, 2022
(86) PCT No.: PCT/JP2022/027030

§ 371 Date: Jan. 4, 2025

(51) Int. Cl. H04W 16/28; H04W 72/044; H04W 72/12

(52) U.S. Cl. CPC H04W 16/28; H04W 72/044; H04W 72/12

(57) ABSTRACT

A wireless communication system is a wireless communication system including a base station that transmits and receives a signal to and from a terminal, and a relay station that relays a signal between the base station and the terminal, in which the base station includes a scheduling function unit that determines a schedule of transmission and reception of signals to and from a plurality of terminals 20, and transmits schedule information indicating the determined schedule to the relay station, and the relay station includes a schedule information acquisition unit that acquires the schedule information from the base station, and a beam control unit that specifies a terminal being a transmission destination based on the schedule information, and controls a beam used for relay for each terminal specified as a transmission destination based on a beam number specified for each terminal in advance.

### TECHNICAL FIELD

The present invention relates to a wireless communication system, a relay station, and a relay method.

### BACKGROUND ART

In wireless communication, improvement in the quality of a relay station that relays communication between a base station and a terminal has been studied. For example, NPL 1 discloses a technique in which wireless equipment having a relay function is loaded on a moving object (forklift) that travels and moves around a factory or the like, and on-off control is performed as necessary.

### Citation List

### Non Patent Literature

NPL 1Daisuke Murayama et al., A study on a flexible utilization method of a high frequency band in a closed environment with high shielding density, IEICE 2022 General Conference B-5-27

### SUMMARY OF INVENTION

### Technical Problem

A relay station in a wireless communication network performs relay retransmission even for a signal that does not require relay, and thus there is a possibility of causing radio wave interference. However, a method of reducing radio wave interference caused by a signal transmitted by a relay station has not been provided.

An object of the disclosed technique is to reduce radio wave interference caused by a signal transmitted by a relay station in a wireless communication network.

### Solution to Problem

A disclosed technique is a wireless communication system including a base station that transmits and receives a signal to and from a terminal, and a relay station that relays a signal between the base station and the terminal, in which the base station includes a scheduling function unit that determines a schedule of transmission and reception of signals to and from a plurality of terminals 20, and transmits schedule information indicating the determined schedule to the relay station, and the relay station includes a schedule information acquisition unit that acquires the schedule information from the base station, and a beam control unit that specifies a terminal being a transmission destination based on the schedule information, and controls a beam used for relay for each terminal specified as a transmission destination based on a beam number specified for each terminal in advance.

### Advantageous Effects of Invention

It is possible to reduce radio wave interference due to a signal transmitted by a relay station in a wireless communication network.

### BRIEF DESCRIPTION OF DRAWINGS

FIG. 1 is a diagram showing an example of a configuration of a wireless communication system according to an embodiment of the present invention.

FIG. 2 is a diagram showing an example of functional configurations of a base station and a relay station included in the wireless communication system according to the embodiment of the present invention.

FIG. 3 is a flowchart showing an example of a flow of relay processing according to the embodiment of the present invention.

FIG. 4 is a diagram showing an example of a hardware configuration of a computer.

### DESCRIPTION OF EMBODIMENTS

Hereinafter, an embodiment of the present invention (present embodiment) will be described with reference to the drawings. The embodiment described below is merely an example, and embodiments to which the present invention is applied are not limited to the following embodiment.

### Outline of Present Embodiment

In the present embodiment, an example in which a signal is relayed using a beam controlled for each terminal based on a beam number previously acquired for each terminal by a relay station will be described.

### Overall Configuration of Present Embodiment

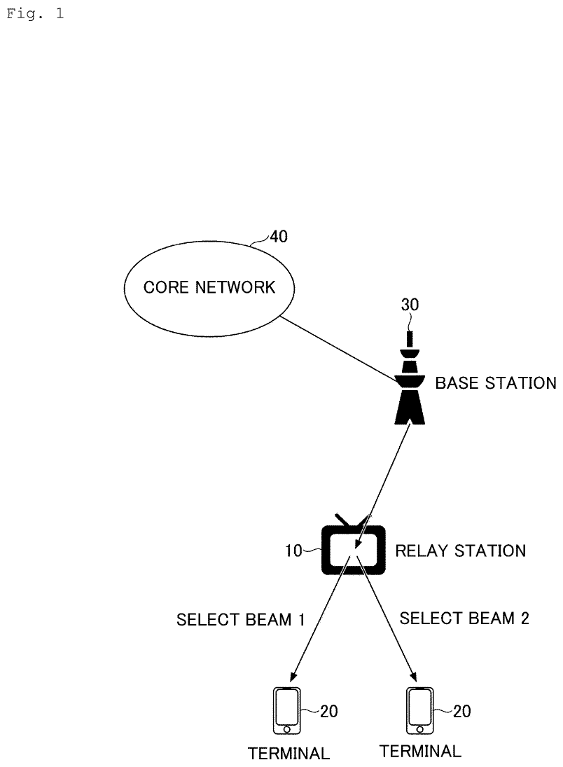

FIG. 1 is a diagram showing an example of a configuration of a wireless communication system according to the present embodiment. A wireless communication system 1 includes a relay station 10, a terminal 20, a base station 30, and a core network 40. The base stations 30 and the core network 40 are communicatively connected to each other by a wired or wireless communication method.

The relay station 10 is a device that relays signals in communication between the base station 30 and a plurality of terminals 20. The relay station 10 receives information (hereinafter, schedule information) indicating a schedule of signal transmission and reception from the base station 30, selects a beam for each terminal 20 based on the schedule information, and relays signals using the selected beam.

The base station 30 receives information necessary for control from the core network 40 and transmits and receives signals to and from the terminal 20 via the relay station 10. The base station 30 transmits the schedule information to the relay station 10 (or the terminal 20).

The terminal 20 is, for example, a mobile station and transmits and receives signals to and from the base station 30 via the relay station 10.

### Functional Configurations of Base Station and Relay Station

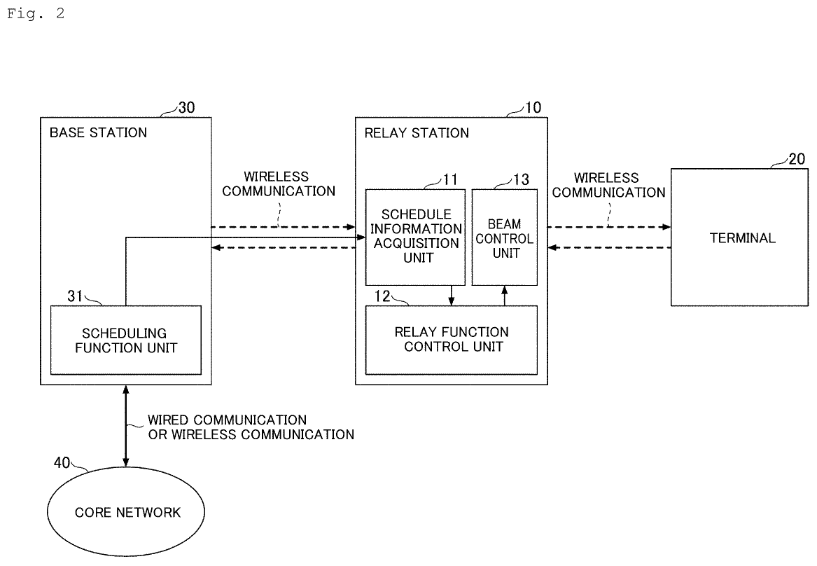

FIG. 2 is a diagram showing an example of functional configurations of a base station and a relay station included in the wireless communication system according to the present embodiment. The base station 30 includes a scheduling function unit 31.

The scheduling function unit 31 determines a schedule of transmission and reception of signals to and from the plurality of terminals 20, and transmits schedule information indicating the determined schedule to the relay station 10. The schedule information may include, for example, a terminal ID for identifying each terminal, allocated transmission resources (frequency and time slots (resource blocks)), and the like.

In addition, the relay station 10 includes a schedule information acquisition unit 11, a relay function control unit 12, and a beam control unit 13. The schedule information acquisition unit 11 receives schedule information from the base station 30 via wireless communication. For example, the schedule information may be included in a physical downlink control channel (PDCCH) transmitted to the terminal 20 or the relay station 10. That is, the schedule information acquisition unit 11 may acquire the schedule information by receiving the PDCCH and decoding the received PDCCH.

The relay function control unit 12 controls a relay function for relaying a signal between the base station 30 and the terminal 20. For example, the relay function control unit 12 may specify either or both of a time resource and a frequency resource of a signal which is a signal relayed by the relay station 10 itself and transmitted or received to or from the terminal 20 based on the schedule information, and may turn on (validate) a relay function only when either or both of the specified time resource and frequency resource are used.

The beam control unit 13 controls a beam used when transmitting a signal to each terminal 20. Specifically, the beam control unit 13 may specify the terminal 20 being a transmission destination based on the schedule information, and may determine a beam to be used for each terminal 20 specified as a transmission destination, based on a beam number specified for each terminal 20 in advance.

### Operations According to Present Embodiment

Next, an operation of the relay station 10 will be described with reference to the accompanying drawings. In order to control a relay operation in accordance with scheduling of the base station 30, the relay station 10 needs to be synchronized with the base station 30 and the terminal 20 in advance. In the synchronization of the relay station 10 and the base station 30, the relay station 10 may be synchronized, for example, in accordance with a synchronization signal (primary synchronization signal (PSS)/secondary synchronization signal (SSS) ) received from the base station 30 (as in the initial access procedure of (5G NewRadio). The relay station 10 may update a clock each time the synchronization signal periodically transmitted from the base station 30 is received. In addition, synchronization between the relay station 10 and the terminal 20 may be realized by the relay station 10 or the terminal 20 synchronizing in accordance with a synchronization signal received from the base station 30, or the relay station 10 periodically transmitting the synchronization signal and the terminal 20 updating a clock in accordance with the synchronization signal.

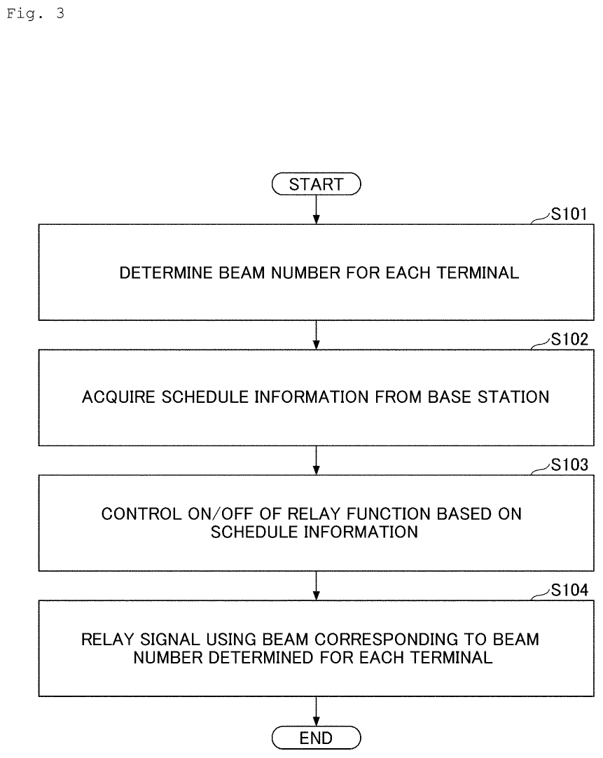

FIG. 3 is a flowchart showing an example of a flow of relay processing according to the present embodiment. The relay station 10 determines a beam number to be used for each terminal 20 at the beginning of the relay processing (step S101). For example, the relay station 10 transmits a beamforming synchronization signal and physical broadcast channel (SS/PBCH) block a plurality of times using different beams.

SS/PBCH is a downlink signal broadcasted at the time of initial connection. The SS/PBCH block is a signal block in which a synchronization signal and notification information become a set. When there are a plurality of beam forming patterns, the relay station 10 transmits the SS/PBCH block using different beams. The plurality of same beams may mean that the plurality of beams have a quasi co location (QCL) relationship.

The terminal 20 transmits a physical random access channel (PRACH) to the relay station 10 by using a resource corresponding to a high quality beam from the received SS/PBCH block. The PRACH is an uplink signal transmitted through a random access procedure using a resource designated for an SS/PBCH block with high reception quality. The relay station 10 receives the PRACH from the terminal 20 and determines a beam number to be used for each terminal 20 based on the received PRACH.

The relay station 10 may re-execute the processing of step S101 at a fixed time interval or at a timing when the synchronization with the terminal 20 is canceled.

Next, the schedule information acquisition unit 11 acquires schedule information from the base station 30 (step S102). Specifically, the schedule information acquisition unit 11 extracts schedule information from the PDCCH transmitted from the base station 30. When the relay station 10 decodes the PDCCH transmitted from the base station 30, the relay station 10 may relay a signal by a reproduction relay system or a non-reproduction relay system.

The relay function control unit 12 controls ON/OFF of a relay function based on the schedule information (step S103). For example, the relay function control unit 12 specifies either or both of a time resource and a frequency resource of a signal which is a signal relayed by the relay station 10 itself and transmitted or received to or from the terminal 20 based on the schedule information, and turns on (validate) a relay function only when either or both of the specified time resource and frequency resource are used. Thereby, the relay station 10 can perform relay for only the terminal 20 connected to itself (transmitting the PRACH).

Subsequently, the beam control unit 13 relays, toward the terminal 20, a signal transmitted from the base station 30 toward the terminal 20 by using a beam corresponding to a beam number determined for each terminal 20 (step S104).

Specifically, the beam control unit 13 specifies the terminal 20 being a transmission destination based on the schedule information, and determines a beam to be used for each terminal 20 specified as a transmission destination based on a beam number specified for each terminal 20 in advance.

According to the relay station 10 of the present embodiment, signals can be relayed only when relay is required. Thereby, it is possible to suppress interference applied to other devices, terminals and the like, suppress emission of unnecessary beams, and reduce power consumption. Further, the relay station 10 can transmit a signal to the terminal 20 by using a beam formed by beam forming. Thereby, it is possible to suppress interference applied to other devices, terminals and the like and improve radio wave quality of transmission and reception to and from a desired terminal 20. Thereby, it is possible to reduce radio wave interference due to a signal transmitted by the relay station in a wireless communication network.

### Hardware Configuration

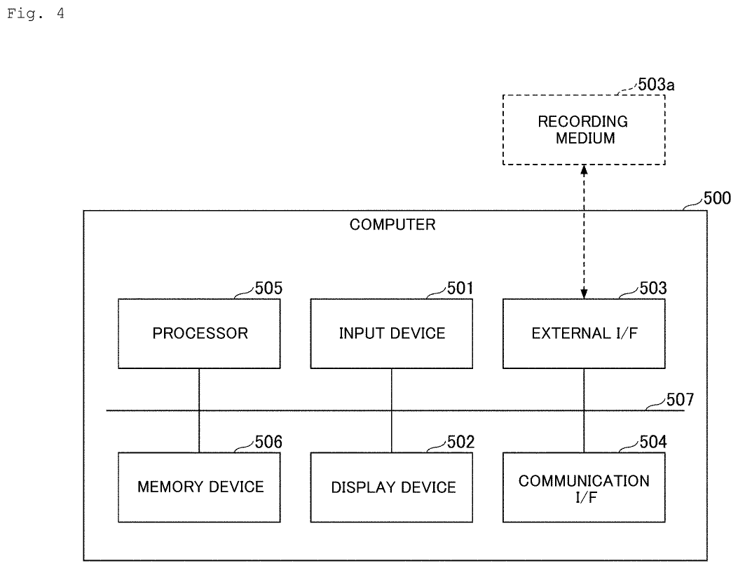

Finally, a hardware configuration of the relay station 10, the terminal 20, or the base station 30 according to the present embodiment will be described. The relay station 10, the terminal 20, or the base station 30 according to the present embodiment are implemented by, for example, a hardware configuration of a computer 500 shown in FIG. 4.

The computer 500 shown in FIG. 4 includes an input device 501, a display device 502, an external I/F 503, a communication I/F 504, a processor 505, and a memory device 506. These pieces of hardware are communicatively connected via a bus 507.

The input device 501 is, for example, a keyboard, a mouse, or a touch panel. The display device 502 is, for example, a display. The computer 500 may not include at least one of the input device 501 and the display device 502.

The external I/F 503 is an interface with an external device such as a recording medium 503a. Examples of the recording medium 503a include a compact disc (CD), a digital versatile disk (DVD), a secure digital (SD) memory card, a universal serial bus (USB) memory card, and the like.

The communication I/F 504 is an interface for performing data communication with other devices, equipment, systems, and the like. The processor 505 is, for example, any of various arithmetic devices such as a CPU. The memory device 506 is, for example, any of various storage devices such as an HDD, an SSD, a random access memory (RAM), a read only memory (ROM), and a flash memory.

The relay station 10, the terminal 20, or the base station 30 according to the present embodiment can realize the various types of processing described above by having the hardware configuration of the computer 500 shown in FIG. 4. The hardware configuration of the computer 500 shown in FIG. 4 is an example, and the computer 500 may have other hardware configurations. For example, the computer 500 may include a plurality of processors 505 or may include a plurality of memory devices 506.

The relay station 10, the terminal 20, or the base station 30 according to the present embodiment are realized by reading a program for causing the computer 500 to execute the above-described processes and executing processes specified by the program. Further, the program may be stored in the recording medium 503a or the like or may be provided via a network.

### Summary of Embodiment

In the present specification, a wireless communication system, a relay station, and a relay method described in at least the following items are described.

### Item 1

A wireless communication system including:
a base station that transmits and receives a signal to and from a terminal; and
a relay station that relays a signal between the base station and the terminal, wherein
the base station includes a scheduling function unit that determines a schedule of transmission and reception of signals to and from a plurality of terminals 20, and transmits schedule information indicating the determined schedule to the relay station, and the relay station includes a schedule information acquisition unit that acquires the schedule information from the base station, and a beam control unit that specifies a terminal being a transmission destination based on the schedule information, and controls a beam used for relay for each terminal specified as a transmission destination based on a beam number specified for each terminal in advance.

### Item 2

The wireless communication system according to item 1, wherein the relay station further includes a relay function control unit that controls whether to validate a function of relaying a signal between the base station and the terminal based on the schedule information.

### Item 3

The wireless communication system according to item 2, wherein the relay function control unit specifies either or both of a time resource and a frequency resource of a signal which is a signal relayed by the relay function control unit itself and transmitted or received to or from the terminal based on the schedule information, and validates a function of relaying a signal between the base station and the terminal when either or both of the specified time resource and frequency resource are used.

### Item 4

A relay station that relays a signal between a base station and a terminal, the relay station including: a schedule information acquisition unit that acquires schedule information from the base station; and a beam control unit that specifies a terminal being a transmission destination based on the schedule information, and controls a beam used for relay for each terminal specified as a transmission destination based on a beam number specified for each terminal in advance.

### Item 5

A relay method executed by a relay station that relays a signal between a base station and a terminal, the relay method including: acquiring schedule information from the base station; and specifying a terminal being a transmission destination based on the schedule information, and controlling a beam used for relay for each terminal specified as a transmission destination based on a beam number specified for each terminal in advance.

Although the present embodiment has been described above, the present invention is not limited to such a specific embodiment and various modifications and changes can be made within the scope of the gist of the present invention described in the claims.

### Reference Signs List

1 Wireless communication system
10 Relay station
11 Schedule information acquisition unit
12 Relay device control unit
13 Beam control unit
20 Terminal
30 Base station
31 Scheduling function unit
40 Core network
500 Computer
501 Input device
502 Display device
503 External I/F
503a Recording medium
504 Communication I/F
505 Processor
506 Memory device
507 Bus

1. A wireless communication system comprising:
a base station that transmits and receives a signal to and from a terminal; and
a relay station that relays a signal between the base station and the terminal,
wherein
the base station includes a scheduling function circuitry that determines a schedule of transmission and reception of signals to and from a plurality of terminals 20, and transmits schedule information indicating the determined schedule to the relay station, and
the relay station includes:
a schedule information acquisition circuitry that acquires the schedule information from the base station, and
a beam control circuitry that specifies a terminal being a transmission destination based on the schedule information, and controls a beam used for relay for each terminal specified as a transmission destination based on a beam number specified for each terminal in advance.

2. The wireless communication system according to claim 1, wherein
the relay station further includes a relay function control circuitry that controls whether to validate a function of relaying a signal between the base station and the terminal based on the schedule information.

3. The wireless communication system according to claim 2, wherein
the relay function control circuitry specifies either or both of a time resource and a frequency resource of a signal which is a signal relayed by the relay function control circuitry itself and transmitted or received to or from the terminal based on the schedule information, and validates a function of relaying a signal between the base station and the terminal when either or both of the specified time resource and frequency resource are used.

4. A relay station that relays a signal between a base station and a terminal, the relay station comprising:
a schedule information acquisition circuitry that acquires schedule information from the base station; and
a beam control circuitry that specifies a terminal being a transmission destination based on the schedule information, and controls a beam used for relay for each terminal specified as a transmission destination based on a beam number specified for each terminal in advance.

5. A relay method executed by a relay station that relays a signal between a base station and a terminal, the relay method comprising:
acquiring schedule information from the base station; and
specifying a terminal being a transmission destination based on the schedule information, and controlling a beam used for relay for each terminal specified as a transmission destination based on a beam number specified for each terminal in advance.
